(19) United States
(12) Patent Application Publication
(10) Pub. No.: US 2014/0199938 A1
(43) Pub. Date: Jul. 17, 2014

(54) APPARATUS FOR EXHAUSTING AIR

(71) Applicant: Fusion HVAC Pty Limited, West End (AU)

(72) Inventors: Sean Michael Johl Badenhorst, Dulwich Hill (AU); Kevin Harris, West End (AU)

(21) Appl. No.: 14/201,625

(22) Filed: Mar. 7, 2014

Related U.S. Application Data
(63) Continuation of application No. PCT/AU2013/000137, filed on Feb. 18, 2013.

(30) Foreign Application Priority Data
Jan. 15, 2013 (AU) 2013900121

(51) Int. Cl. F24F 7/06; A62C 2/06; E04F 17/04

(52) U.S. Cl. CPC F24F 7/06; E04F 17/04; A62C 3/14
USPC 454/342; 454/357; 454/345

(57) ABSTRACT

An apparatus for exhausting air from a space. The space may comprise the interior space(s) of buildings such as hospitals, enclosed shopping malls, warehouses, factories, high rise buildings, etc. The apparatus comprises at least a first discharging arrangement in the form of return and supply air ducts of an air handling unit (AHU). The apparatus also comprises a second discharging arrangement in the form of a smoke exhaust box. The return air duct is arranged to receive an air stream discharged from the space and is able to be isolated from the smoke exhaust box. Upon isolation of the return air duct, the smoke exhaust box is able to receive and discharge an air stream (e.g. a smoke-filled or contaminated air stream) from the space.

### BACKGROUND OF THE INVENTION

Apparatus for exhausting air from a space is disclosed. The apparatus comprises first and second air discharging arrangements, with the second discharging arrangement being externally cantilevered from the first discharging arrangement. The second discharging arrangement may take the form of a smoke exhaust unit (e.g. smoke exhaust box). The apparatus can be employed in applications such as heating, ventilation and air conditioning (HVAC) systems for buildings. The apparatus can be mounted to or incorporated as part of an air handling unit that forms part of an air delivery system for such HVAC applications.

HVAC systems are often fitted to buildings to maintain a controlled environment within an occupied space. Ventilation systems include smoke control systems operable to remove smoke from a building. Smoke control systems include a combination of fans, dampers, warning devices and control equipment. Buildings that are likely to have smoke control systems include hospitals, enclosed shopping malls, warehouses, factories and high rise buildings.

Smoke control systems are installed in buildings to protect the lives of occupants and reduce damage to property. National building codes (e.g. the Building Code of Australia) can require that a smoke control system be fitted to certain types of buildings.

Smoke control systems may be classed as dedicated or non-dedicated systems. Non-dedicated smoke control systems are used during normal HVAC operation and during a smoke event. When smoke control mode is activated in a non-dedicated smoke control system, the operation of the building's HVAC equipment changes. These systems involve a complicated control strategy and may also require additional control and monitoring points.

Dedicated smoke control systems can include mechanically powered smoke exhaust fans that are automatically switched on in a smoke event to maintain a negative pressure in a smoke filled space. The intention of a mechanically powered smoke exhaust fan is to maintain a negative pressure relative to the surrounding space so that the smoke does not migrate to undesirable areas. To maintain a negative pressure in a smoke filled area, the supply air and return air fans of an air handling unit (AHU) are usually disabled. This also prevents smoke from being re-circulated back into the building. In spaces with a high void above the occupancy space, warm smoke will rise by natural convection to fill the void, which will act as a smoke reservoir in which smoke is collected. In such instances, smoke exhaust fans may be used to draw smoke from the smoke reservoir to prevent the smoke level from dropping down to the height of occupants, and for a sufficient period of time to allow the occupants to escape.

Disadvantages of dedicated smoke control systems are that they require additional space, structural support, ducts, dampers and electrical wiring to the building's normal operation HVAC system. Dedicated smoke exhaust systems must be capable of continuous operation at elevated temperatures for a long period of time.

The above references to the background art do not constitute an admission that the art forms a part of the common general knowledge of a person of ordinary skill in the art. The above references are also not intended to limit the application of the apparatus as disclosed herein.

### SUMMARY OF THE INVENTION

Disclosed herein is an apparatus for exhausting air from a space. The space may comprise the interior space(s) of buildings such as hospitals, enclosed shopping malls, warehouses, factories, high rise buildings, etc.

The apparatus comprises at least first and second discharging arrangements. The first discharging arrangement is arranged to receive an air stream discharged from the space and is able to be isolated from the second discharging arrangement. Upon isolation of the first discharging arrangement, the second discharging arrangement is able to receive an air stream discharged from the space.

In one embodiment, both the first and the second discharging arrangements may draw simultaneously from the air stream discharged from the space.

In one embodiment, the first discharging arrangement may comprise a section of an air handling unit, forming part of an HVAC system. In one embodiment, the second discharging arrangement may comprise a smoke exhaust fan, forming part of an HVAC and smoke control system.

In accordance with the apparatus as disclosed herein, the second discharging arrangement is externally cantilevered from the first discharging arrangement. This is to be contrasted with prior art apparatus, whereby a smoke exhaust fan is supported independently of an AHU. The cantilevered second discharging arrangement can also occupy less space and require less structural support than prior art apparatus.

In order to facilitate the cantilever of the second discharging arrangement from the first discharging arrangement, at least one support member may be mounted to the second discharging arrangement. The at least one support member may extend from the wall of the first discharging arrangement towards a remote edge of the second discharging arrangement.

In one embodiment, the second discharging arrangement may have a roof and the first discharging arrangement may have a wall. The roof of the second discharging arrangement may form part of an enclosure for a smoke exhaust fan. The wall of the first discharging arrangement may form part of an enclosure of an AHU.

The at least one support member may be positioned above the roof of the second discharging arrangement and may be mounted thereto. The at least one support member may be mounted to extend from the first wall member of the first discharging arrangement. In one embodiment, the at least one support member may be welded to each of the roof of the second discharging arrangement and the first wall member of the first discharging arrangement.

Another support member may be provided to further facilitate the cantilever of the second discharging arrangement from the first discharging arrangement. In this embodiment, the other support member may extend from the first discharging arrangement and may be mounted to the second discharging arrangement in a like manner to the at least one support member. In this arrangement, the other support member may be laterally spaced from the at least one support member. Additional support member(s) may further be provided to facilitate the cantilever of the second discharging arrangement from the first discharging arrangement.

In some forms, a third discharging arrangement is provided, arranged to exhaust the air stream from the space. In this embodiment, the third discharging arrangement may be a fire rated return air plenum forming part of an HVAC system. The third discharging arrangement may be arranged to connect to the first discharging arrangement and to the second discharging arrangement.

In one embodiment, upon isolation of the second discharging arrangement, the first discharging arrangement may be arranged to receive the air stream from the third discharging arrangement. In this arrangement, a first aperture may be located between the first and third discharging arrangements, through which the air stream may be selectively caused to pass. For example, an AHU in normal run mode may draw air from the third discharging arrangement before returning a proportion of the returned air to the space.

Alternatively, upon isolation of the first discharging arrangement, the second discharging arrangement may be arranged to receive air from the third discharging arrangement. In this arrangement a second aperture may be located between the second and third discharging arrangements, through which the air stream can be selectively caused to pass. For example, when an HVAC system is in fire mode, to prevent air passing through an AHU and possibly back to the space, exhausted smoke may be diverted and solely discharged through the second discharging arrangement.

As a third possibility, upon a partial opening/closing (i.e. throttling) of the first and second apertures, both the first and the second discharging arrangements may partially be isolated, so that the air passes through both apertures to be received by both discharging arrangements. For example, such a configuration may be employed when an HVAC system is in a partial economiser mode, whereby all of the return air may be prevented from being recirculated, and instead a portion of the return air that is not recirculated may be exhausted to outdoors.

To selectively close the aforementioned first aperture, a damper may be mounted to the first discharge arrangement. The damper, which may be a fire rated damper, can be manipulable to close the first aperture, and in turn, isolate the first discharging arrangement. To selectively close the aforementioned second aperture, another damper may be mounted adjacent the first discharge arrangement. The damper, which may be a fire rated damper, can be manipulable to close the second aperture, and in turn, isolate the second discharging arrangement.

In at least one embodiment, the second discharging arrangement may comprise at least one direct drive fan located therein, positioned such that air is drawn into the second discharging arrangement to be exhausted therefrom when the first aperture is closed or throttled.

In some forms, the third discharging arrangement may be incorporated into a unit that also incorporates the first discharging arrangement. By incorporating the third discharging arrangement into the first discharging arrangement, the apparatus as disclosed herein may require less duct, dampers, electrical wiring and controls wiring when contrasted with prior art apparatus.

In this arrangement, the first discharging arrangement may comprise at least one variable speed fan therein, positioned to cause air to be drawn into the first discharging arrangement to be returned to the space, when the second aperture is closed. An example of this arrangement may occur when the third discharging arrangement forms part of a return air plenum located on the suction side of a return air or supply air fan within an AHU.

### BRIEF DESCRIPTION OF THE DRAWINGS

Further embodiments of the present apparatus will become apparent from the following description which is given by way of example only and with reference to the accompanying drawings in which:

FIG. 1 shows a perspective view of an HVAC system incorporating the present apparatus;

FIG. 2 shows a top view of the HVAC system of FIG. 1;

FIG. 3 shows an enlargement in front view of part of the system of FIG. 1;

FIG. 4 shows an enlargement in side view of part of the system of FIG. 1;

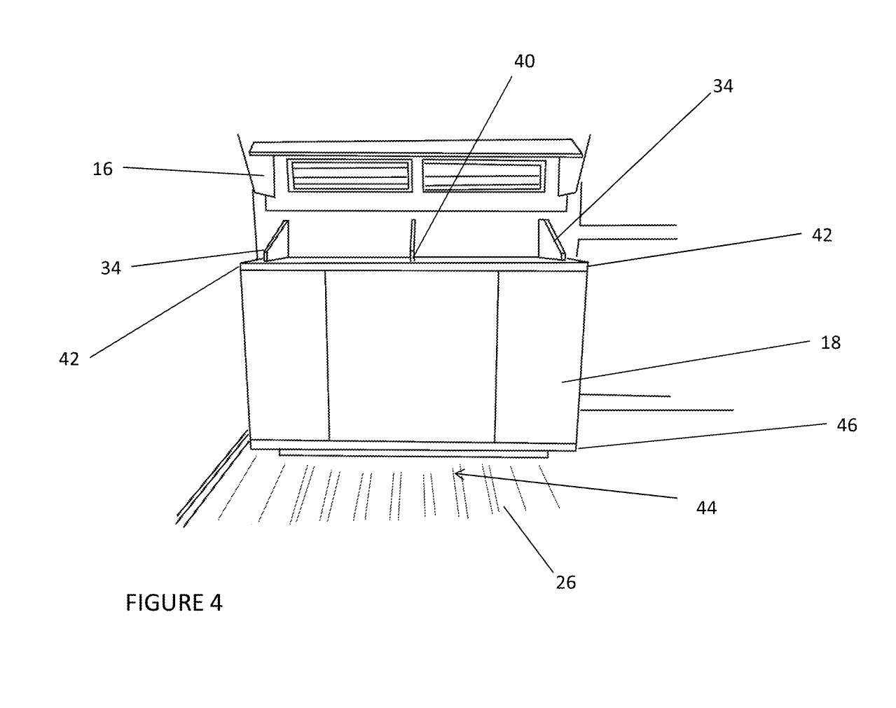

FIG. 5 shows a detail in rear view of part of the system of FIG. 1;

FIG. 6 shows a schematic cross section through part of an HVAC system incorporating the present apparatus.

FIG. 7 shows a schematic cross section through part of the HVAC system showing the damper arrangement.

### DETAILED DESCRIPTION

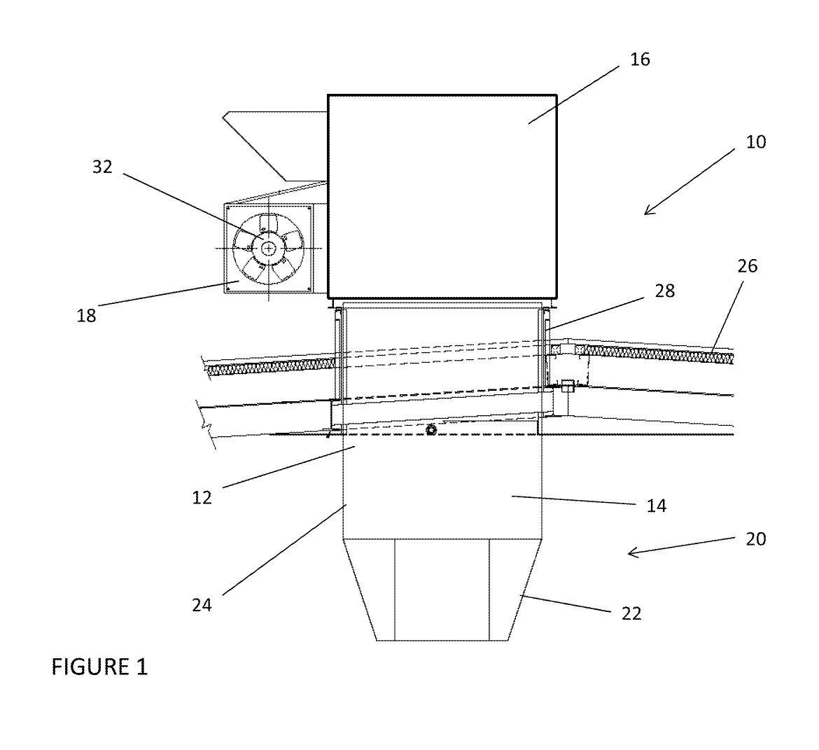

Referring firstly to FIG. 1, an apparatus for exhausting air from a space 20 is shown in the form of an HVAC system 10. The space may comprise the interior space(s) of buildings such as enclosed shopping malls, warehouses, factories, hospitals, high rise buildings, etc.

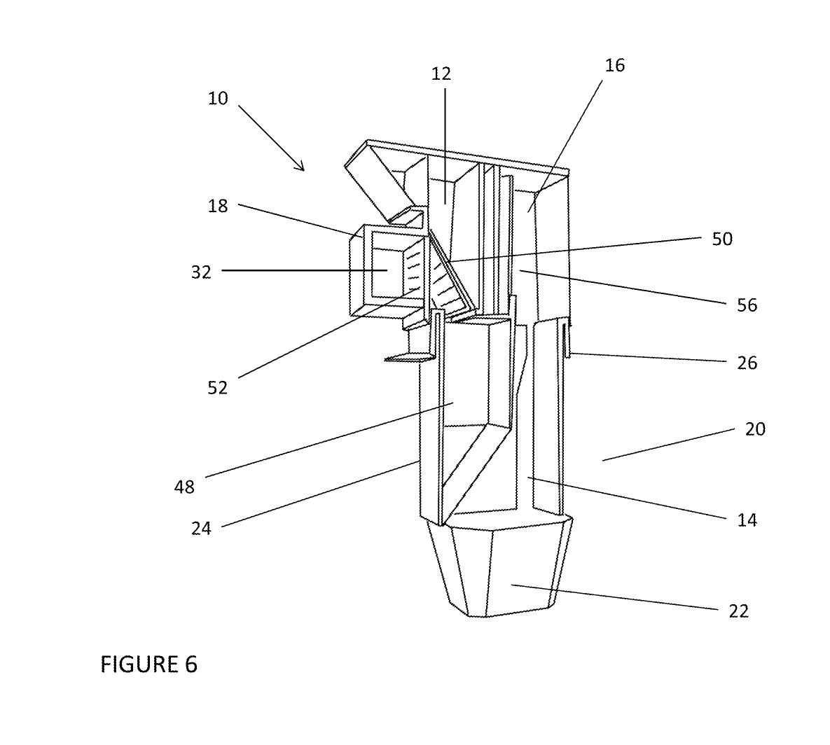

Referring now to FIGS. 1 and 6, the HVAC system 10 will now be described in greater detail. The HVAC system 10 comprises at least a first discharging arrangement in the form of return 12 and supply air ducts 14 of an air handling unit (AHU) 16. The HVAC system 10 also comprises a second discharging arrangement in the form of a smoke exhaust box 18. The return air duct 12 is arranged to receive an air stream discharged from the space 20 and is able to be isolated from the smoke exhaust box 18. Upon isolation of the return air duct 12, the smoke exhaust box 18 is able to receive and discharge an air stream (e.g. a smoke-filled or contaminated air stream) from the space 20.

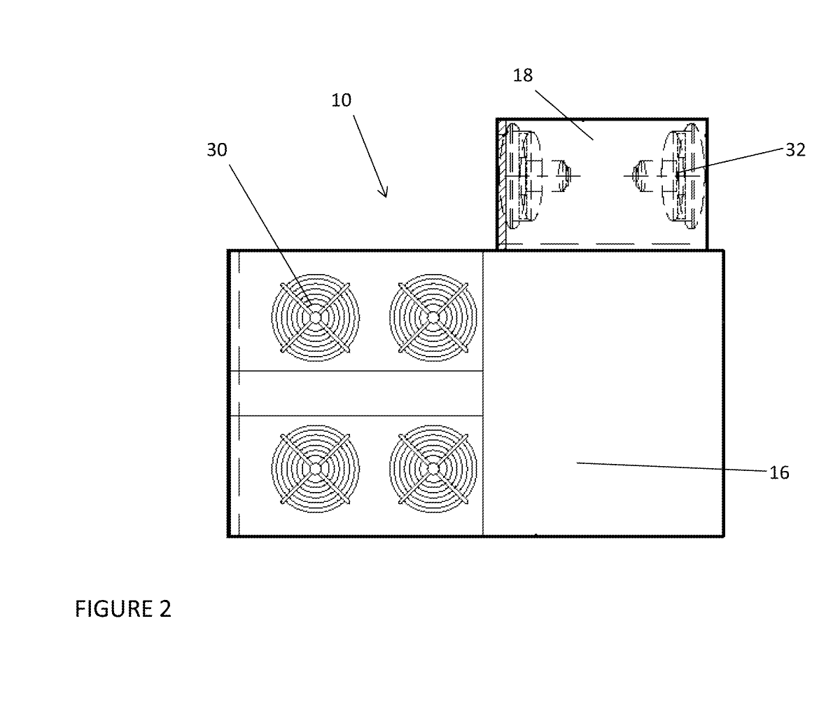

The section of the HVAC system 10 located in the space 20 includes a portion of the supply 14 and return air ducts 12, air delivery diffusers 22 and return air grills 24. The return 12 and supply air ducts 14 protrude through the structural support of the roof 26 to enable meeting with and mounting to the AHU 16, which is located outside the space 20. The AHU 16 is structurally supported by upstands 28 which are supported by the roof 26 of a building. As shown in FIG. 2, the AHU may also comprise condenser units 30 and supply and return air fans (not shown).

A third discharging arrangement is also provided in the form of a return air plenum 48, arranged to exhaust air from the space 20. Return air plenum 48 is fabricated to be fire-rated and to form and integral part of the HVAC system 10. The fire rating of the return air plenum 48 enables the smoke exhaust box 18 to be directly connected to the AHU 16, to enable direct exhausting via the AHU of smoke, etc from the space 20 during a fire event.

The return air plenum 48 is incorporated into the same unit that also incorporates the AHU 16. By incorporating the return air plenum 48 into the AHU, the apparatus as disclosed herein requires less ducting, dampers, electrical wiring and controls wiring when contrasted with prior art apparatus.

In accordance with the teachings herein, the smoke exhaust box 18 is externally cantilevered from the AHU 16 and therefore does not require independent upstands or structural support from the roof 26 of the building. In addition, the smoke exhaust box 18 is not mounted to separate return air ducts or the like. This cantilevered arrangement can occupy less space and require less structural support than prior art arrangements.

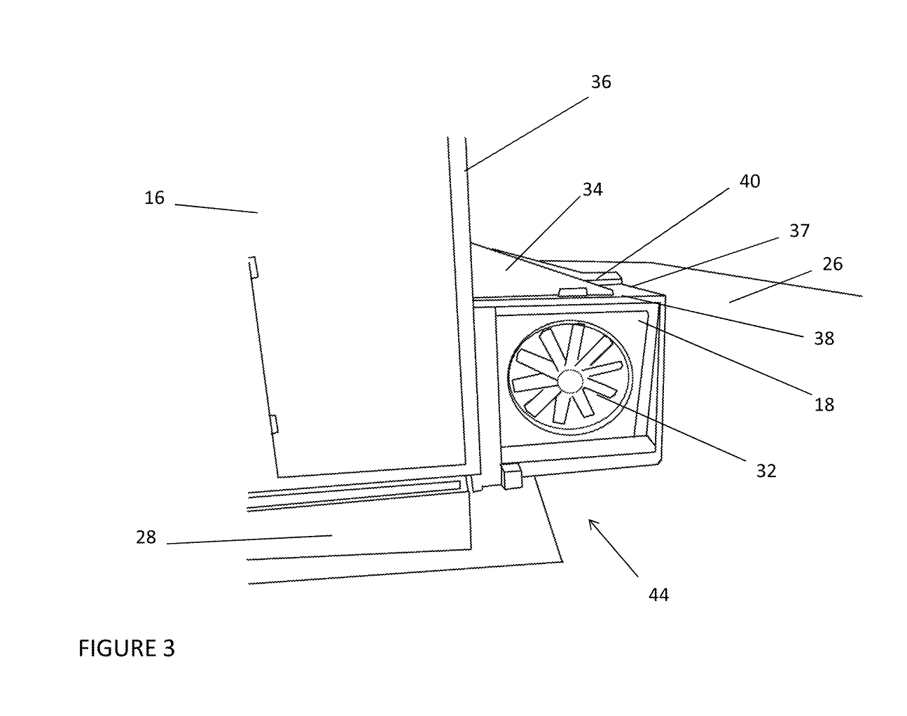

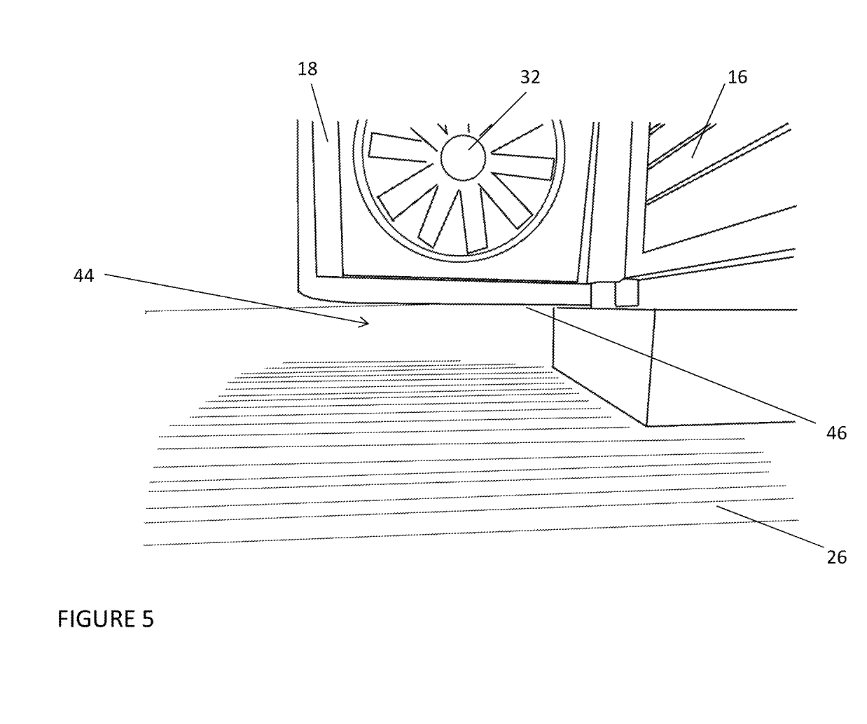

Referring now to FIGS. 3 and 5, an example of the mounting of the smoke exhaust box 18 to the return duct 12 of the AHU 16 will now be shown and described in greater detail. To facilitate the cantilever of the smoke exhaust box 18 from the AHU 16, at least one support member 34 is mounted to the smoke exhaust box 18. In the embodiment shown, two spaced support members 34, in the form of extruded steel plates, extend from the wall 36 of the AHU 16 towards a remote edge 37 of the smoke exhaust box 18. The support members 34 can be welded, riveted, bolted, screwed, etc to each of the AHU 16 and smoke exhaust box 18.

The AHU 16 and smoke exhaust box 18 are incorporated in weather-proof enclosures. The cantilever of the smoke exhaust box 18 from the AHU 16 leaves a gap 44 between the roof 26 and the bottom 46 of the smoke exhaust box. The support members 34 are mounted to the roof 38 of the smoke exhaust box 18 and to the adjacent wall 36 of the AHU 16. In the embodiment shown the support members 34 are welded to the wall 36 of the enclosure of the AHU 16 and above the roof 38 of the smoke exhaust box 18.

Other alternatives to the support members 34, such as rods, bars, struts, etc, can be employed, in combination with other methods of attachment (e.g. bolts, screws, rivets, etc), to facilitate the cantilever of the smoke box 18 from the AHU 16.

A further optional support member in the form of a strut 40 is provided to further facilitate the cantilever of the smoke exhaust box 18 from the AHU 16. The strut 40 extends from AHU 16 and is mounted to the smoke exhaust box 18 in a like manner to the support members 34. In this arrangement, the strut 40 is laterally spaced from and intermediate the two support members 34, the latter of which are located near the outer edges 42 of the smoke exhaust box 18. Additional support member(s) may further be provided to facilitate the cantilever of the smoke exhaust box 18 from the AHU 16.

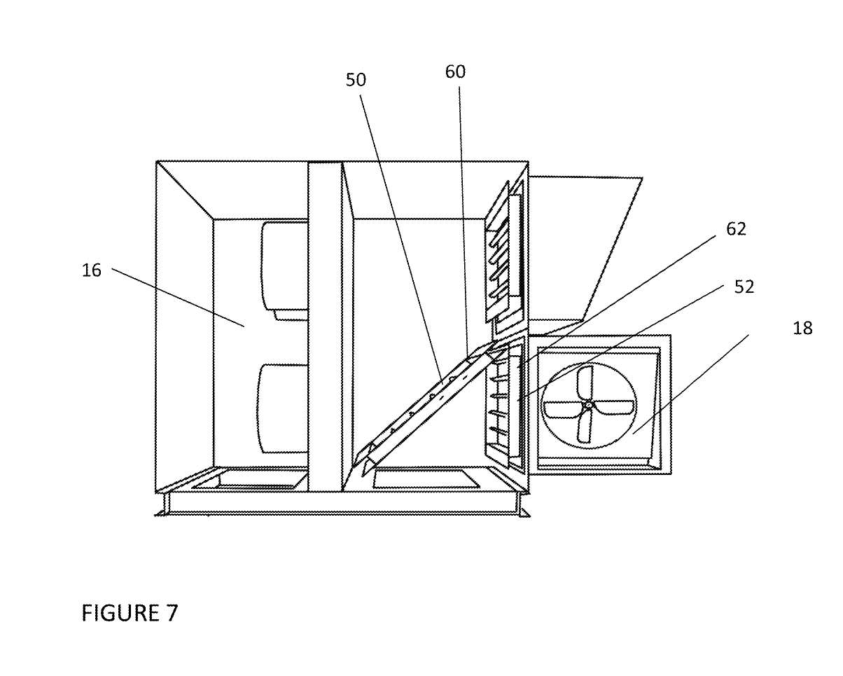

Referring now to FIGS. 6 and 7, the operation of the apparatus will be described. Upon isolation of the smoke exhaust box 18, which is facilitated by the damper arrangements as explained below, the AHU 16 is arranged to receive the air stream from the return air plenum 48. In this arrangement, a first aperture 50 is located between the AHU 16 and the return air plenum 48, through which aperture the air stream may be selectively caused to pass (e.g. for cooling or heating by the AHU).

Alternatively, upon isolation of the AHU 16, the smoke exhaust box 18 is arranged to receive air from the return air plenum 48. In this arrangement a second aperture 52 is located between the smoke exhaust box 18 and the return air plenum 48, through which aperture the air stream can be selectively caused to pass.

To selectively close the aforementioned first and second apertures 50 and 52, two opposed blade dampers 60 and 62 are mounted to and within the AHU 16 adjacent to the return air plenum 48. The opposed blade damper 60, which also comprises a fire-rated damper, is manipulable to close the first aperture 50 and, in turn, isolate the AHU 16. The opposed blade damper 62, which also comprises a fire rated damper, is manipulable to close the second aperture 52 and, in turn, isolate smoke exhaust box 18.

It will also be apparent to those skilled in the art that the opposed blade dampers 60 and 62 may be manipulated to simultaneously throttle the first and second apertures, 50 and 52, allowing the smoke exhaust box 18 and the AHU 16 to simultaneously receive air from the return air plenum 48. This configuration can be employed when the AHU is operating in a partial economiser mode. In this regard, instead of all the return air being recirculated, a portion of the return air that is not recirculated can be exhausted through the smoke exhaust box 18.

The smoke exhaust box 18 itself comprises a direct drive smoke exhaust fan 32 fan located therein, positioned such that air is drawn into the smoke exhaust box 18 to be exhausted therefrom when the first aperture 50 is closed.

The AHU 16 comprises variable speed fans 56 therein, positioned to cause air to be drawn into the AHU to be returned to the space 20, when the second aperture 52 is closed.

Whilst a specific embodiment has been described it should be understood that the apparatus may be embodied in other forms. For example, the AHU may not necessarily connect to a unit housing both supply and return air ducts. In addition, the smoke exhaust box 18 may be cantilevered by an upstanding flange (see e.g. FIG. 6), and optionally a downwardly extending flange, forming part of the enclosure and being connected/connectible to the AHU 16. In addition, as an alternative to the opposed dampers 60 and 62, a single pivoting damper that selectively closes the first and second apertures 50 and 52 can be employed.

In the claims which follow and in the preceding description, except where the context

requires otherwise due to express language or necessary implication, the word “comprise” or variations such as “comprises” or “comprising” is used in an inclusive sense, i.e., to specify the presence of the stated features but not to preclude the presence or addition of further features in various embodiments of the apparatus.

What is claimed is:

1. An apparatus for exhausting air from a space comprising:
a first discharging arrangement arranged to receive an air stream discharged from the space; and
a second discharging arrangement, externally cantilevered from the first discharging arrangement;
the first discharging arrangement able to be isolated from the second discharging arrangement whereby the second discharging arrangement is able to receive the air stream discharged from the space when the first discharging arrangement is isolated.

2. The apparatus for exhausting air in accordance with claim 1, wherein the first discharging arrangement is able to be partially or fully isolated from the second discharging arrangement, whereby the second discharging arrangement is able to receive part or all of the air stream discharged from the space when the first discharging arrangement is partially or fully isolated, respectively.

3. The apparatus for exhausting air in accordance with claim 1, wherein at least one support member is mounted to extend from the first discharging arrangement towards a remote edge of the second discharging arrangement and is mounted to the second discharging arrangement to facilitate the cantilever of the second discharging arrangement from the first discharging arrangement.

4. The apparatus for exhausting air in accordance with claim 3, wherein the second discharging arrangement has a roof, and wherein the at least one support member is positioned above the roof of the second discharging arrangement and is mounted thereto.

5. The apparatus for exhausting air in accordance with claim 4, wherein the first discharging arrangement has a first wall member, and wherein the at least one support member is mounted to extend from the first wall member of the first discharging arrangement.

6. The apparatus for exhausting air in accordance with claim 5, wherein the at least one support member is welded to each of the roof of the second discharging arrangement and the first wall member of the first discharging arrangement.

7. The apparatus for exhausting air in accordance with any one of claims 2, further comprising another support member that extends from the first discharging arrangement and that is mounted to the second discharging arrangement in a like manner to the at least one support member.

8. The apparatus for exhausting air in accordance with claim 7, wherein the other support member is laterally spaced from the at least one support member.

9. The apparatus for exhausting air in accordance with claim 1, wherein the first discharging arrangement and the second discharging arrangement are each directly connected to a third discharging arrangement that is arranged to exhaust the air stream from the space:
wherein the first discharging arrangement is arranged to receive the air stream from the third discharging arrangement when the second discharging arrangement is isolated; and
wherein the second discharging arrangement is arranged to receive the air stream from the third discharging arrangement when the first discharging arrangement is isolated.

10. The apparatus for exhausting air in accordance with claim 9, wherein a first aperture is located between the first and third discharging arrangements and a second aperture is located between the second and third discharging arrangements, through which apertures the air stream can be selectively caused to pass.

11. The apparatus for exhausting air in accordance with claim 10, wherein a damper is mounted to the first discharge arrangement, the damper being manipulable to selectively close the first aperture.

12. The apparatus for exhausting air in accordance with claim 11, wherein another damper is mounted adjacent the first discharge arrangement, the damper being manipulable to selectively close the second aperture.

13. The apparatus for exhausting air in accordance with claim 11, wherein the second discharging arrangement comprises at least one direct drive fan located therein.

14. The apparatus as claimed in claim 13, wherein the at least one direct drive fan causes air to be drawn into the second discharging arrangement to be exhausted therefrom, when the first aperture is closed.

15. The apparatus for exhausting air in accordance with any one of claim 9, wherein the third discharging arrangement is a fire rated return air plenum.

16. The apparatus for exhausting air in accordance with any one of claims 9, wherein the third discharging arrangement is incorporated into a unit that also incorporates the first discharging arrangement.

17. The apparatus for exhausting air in accordance with claim 10, wherein the first discharging arrangement comprises at least one variable speed fan therein.

18. The apparatus as claimed in claim 17, wherein the at least one variable speed fan causes air to be drawn into the first discharging arrangement to be returned to the space, when the second aperture is closed.
